(19) United States
(12) Patent Application Publication
(10) Pub. No.: US 2015/0108729 A1
(43) Pub. Date: Apr. 23, 2015

(54) Bucket cart for adhesive applications

(71) Applicants: Olga Nikolaevna Kolesnikova, Naples, FL (US); Sergey Vladimirovich Chepchugov, Naples, FL (US)

(72) Inventors: Olga Nikolaevna Kolesnikova, Naples, FL (US); Sergey Vladimirovich Chepchugov, Naples, FL (US)

(21) Appl. No.: 14/059,371

(22) Filed: Oct. 21, 2013

(51) Int. Cl. B62B 3/10

(52) U.S. Cl. CPC B62B 3/104
USPC 280/79.5

(57) ABSTRACT

Bucket cart designed for flooring installations of tile, marble, or wood using mud, thin set mortar, glue or other adhesives and grouting, installers have to lift, move, incline bucket, balance it, shovel adhesive and remove bucket from working sector. Using bucket cart allows installer to shovel adhesive without lifting, inclining and balancing bucket every time. Bucket cart is the dog with four wheels or casters attached to the bottom of the ring. Inner opening holds bucket in the variety of angles and fits most five gallons buckets. Amount of adhesive balances bucket on the cart in steady position.

### BACKGROUND OR PROBLEM

In floor installation jobs requiring adhesive application installers have to lift the bucket with adhesive, move it close to the application sector, which should be covered next, incline the bucket, shovel adhesive, then remove bucket away from application sector, trowel the adhesive, install tile, marble or wood and move to the next sector. Depending on job size installers have to repeat all movements all over again and again until job is finished. Considering that ready to use or ready to mix adhesives come in 50-60 lb quantities, it is a lot of heavy lifting for installers. Existing bucket carts allow installers to move bucket in vertical or 45 degree position. To apply adhesive from such cart installers still have to lift, incline the bucket, balance it when shoveling adhesive and lift it back to the vertical or 45 degree position.

### Solution:

Bucket cart for adhesive applications can hold bucket in different positions in variety of angles, so installer can move the cart with the bucket easily and shovel adhesive without lifting and inclining bucket every time. Amount of adhesive in the bucket balances bucket on the cart in desirable degree. Inner opening of the cart supports side of the bucket.

### DETAILED DESCRIPTION OF INVENTION

Bucket cart for adhesive applications is a ring maiden from different kinds of materials with four or more attached wheels or casters. Inner opening is 9½ inches in diameter, which fits most five gallons buckets. Wheels or casters are 2 inches or higher.

### DETAILED DESCRIPTION OF DRAWINGS ATTACHED

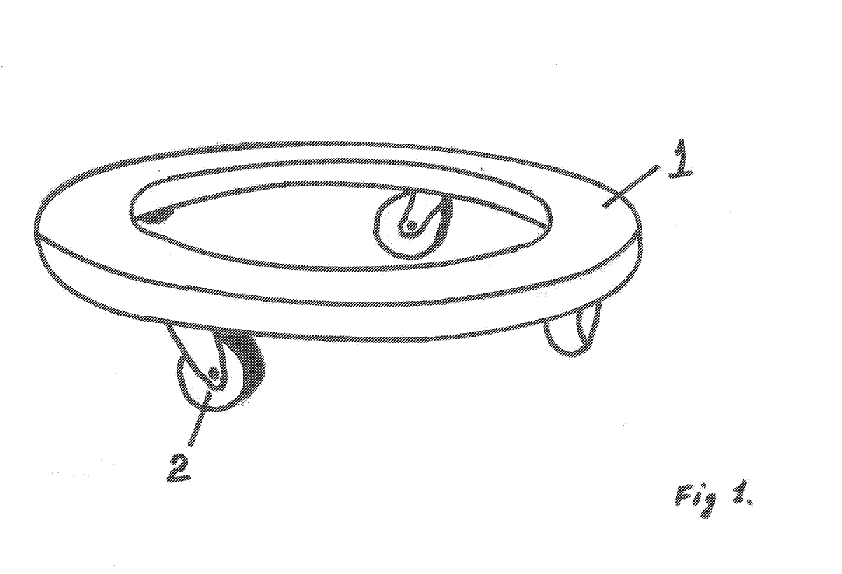

FIG. 1. Shows perspective view of bucket cart. 1-ring, 2-wheels or casters.

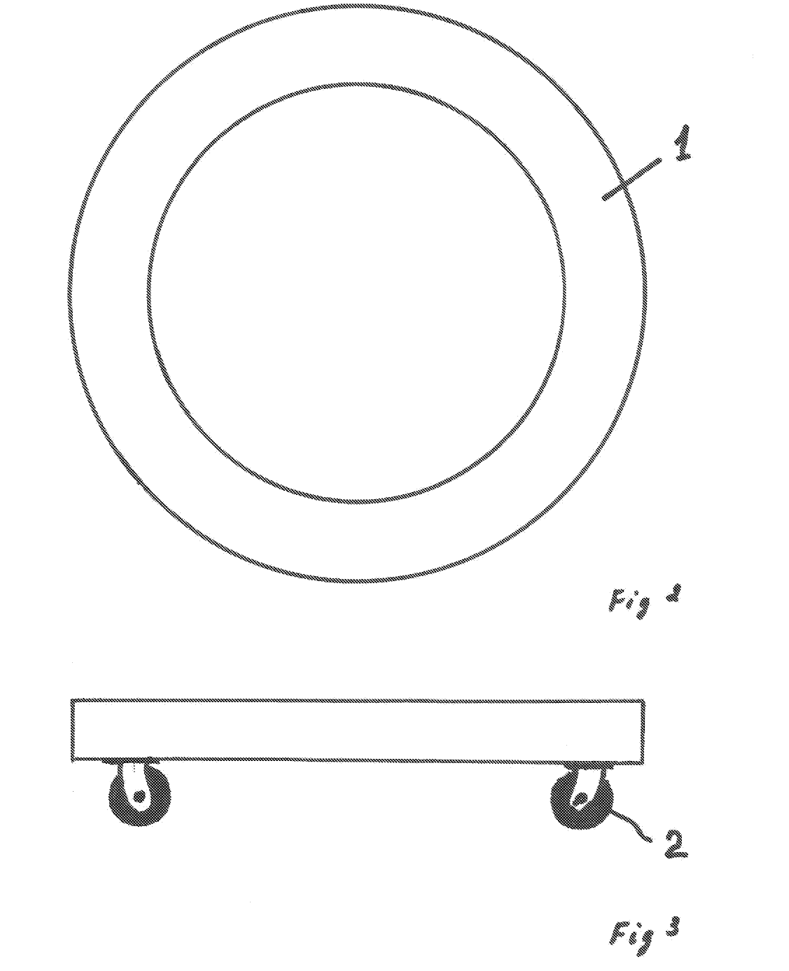

FIG. 2. Shows bucket cart view from the above.

FIG. 3. Shows bucket cart view from the side.

We claim:

1. Bucket cart for adhesive applications, comprising: a ring with four or more wheels or casters attached to the bottom side of the ring.

2. Bucket cart in claim 1 holds 5 gallons bucket in the variety of angles, inner opening supports side of the bucket.
